(19) United States
(12) Patent Application Publication
(10) Pub. No.: US 2011/0148227 A1
(43) Pub. Date: Jun. 23, 2011

(54) POWER TOOL

(76) Inventors: Manfred Schuele, Sulzbach-Laufen (DE); Bernd Altvater, Althuette-Waldenweiler (DE); Florian Esenwein, Uhingen-Holzhausen (DE)

(21) Appl. No.: 13/060,202

(22) PCT Filed: Jun. 29, 2009
(86) PCT No.: PCT/EP2009/058103

§ 371 Date: Feb. 22, 2011

(51) Int. Cl. H02K 7/14

(52) U.S. Cl. 310/50

(57) ABSTRACT

The invention relates to a power tool having a machine housing and a ventilation unit which is provided for cooling a motor unit and/or an electronics unit encased by the machine housing, the cooling being accomplished by means of suctioning a cooling air flow, and which has a deflection unit. The invention provides that the deflection unit has at least one deflection channel that is provided for separating contaminant particles and air of the cooling air flow by means of a deflecting of the cooling air flow.

### PRIOR ART

The invention is based on a power tool with the defining characteristics of the preamble to claim 1.

A power tool is already known, which has a machine housing and a ventilation unit that is provided for cooling a motor unit and/or electronics unit enclosed in the machine housing by drawing in a cooling air flow; the ventilation unit has a deflecting unit.

### ADVANTAGES OF THE INVENTION

The invention is based on a power tool having a machine housing and a ventilation unit, which is provided for cooling a motor unit and/or electronics unit enclosed in the machine housing, and having a deflecting unit.

According to one proposal, the deflecting unit has at least one deflecting conduit that is provided for deflecting the cooling air flow in order to separate dirt particles from the air of the cooling air flow. In this context, “provided” should in particular be understood to mean specially equipped and/or specially designed. The ventilation unit preferably has a fan for drawing in the cooling air flow or more precisely stated, for producing a suction power during operation of the power tool. In addition, a “deflecting unit” should in particular be understood to be a unit that is preferably situated in the vicinity of and/or inside a ventilation conduit of the ventilation unit and in particular due to the deflection of the cooling air flow, produces a separation, in particular a mass-dependent separation, of dust and/or dirt particles from air, in particular gaseous particles and/or molecules of air. A “deflecting conduit” should in particular be understood here to mean a conduit that is provided for a deliberate guidance of the cooling air flow and deflects the cooling air flow in a provided direction so that it is possible to advantageously avoid a scattering of particles of the cooling air flow, particularly into a region encompassing the conduit along its longitudinal span. Preferably, a separate conduit housing shields the deflecting conduit from other components and/or regions of the power tool. Preferably, the deflection causes a force, in particular a centrifugal force and/or gravitational force, etc., to act on the particles of the cooling air flow, making it possible to carry out a separation of the particles, particularly in a mass-dependent fashion. The cooling air flow is composed of air and dust and/or dirt particles entrained with the air by a suction force of the ventilation unit. Thanks to the embodiment according to the invention, dust and/or dirt particles can be advantageously separated from the air in the cooling air flow so that a virtually dust-free and/or dirt-free cooling air is available for cooling the motor unit and/or electronics unit during operation of the power tool. In addition, it is possible to advantageously reduce or prevent undesired emissions from components and/or elements of the motor unit and/or electronics unit, e.g. a motor winding and/or insulations and thus to advantageously extend the service life of the motor unit and/or electronics unit and to prevent failure of the components and/or the power tool. It is also possible advantageously eliminate additional components such as a dust and/or dirt filter, thus minimizing maintenance costs for the ventilation unit.

According to another proposal, the deflecting conduit has at least one bowed deflecting conduit section. In this context, “bowed” should in particular be understood to mean that the deflecting conduit has a curved deflecting conduit section, preferably with a continuous change in direction. The deflecting conduit section here can be embodied as ring segment-shaped, ellipsoidal, U-shaped, etc. A centrifugal force here can act in a simply designed way on particles of the cooling air flow being conveyed in the deflecting conduit section, thus achieving a mass-dependent spatial separation of the particles, in particular a separation of the dust and/or dirt particles from the air; the heavy dust and/or dirt particles can be deflected away in an outer region of the bowed deflecting conduit section and the air can flow in an inner region of the deflecting conduit section.

In a particularly advantageous way, the deflecting conduit has at least one spiral-shaped deflecting conduit section, permitting achievement of a particularly space-saving, compact deflecting unit. In addition, a particularly effective separation of heavy and light particles of the cooling air flow can be achieved in that a radius of the spiral-shaped deflecting conduit section preferably decreases along the flow direction, thus permitting an advantageous increase in a centrifugal force acting on the particles. The deflecting conduit can also be embodied as conically tapered along the flow direction and/or helically embodied and/or can have other forms deemed suitable by the person of average skill in the art.

According to another proposal, the deflecting conduit has a plurality of deflecting conduit sections; in at least one deflecting conduit section, the cooling air flow has a movement direction oriented essentially opposite a movement direction of the adjacent deflecting conduit sections. In this connection, a “plurality” is in particular understood to be a number of at least two or more than two. In addition, “oriented essentially opposite” should be understood to mean that relative to a reference direction, a direction has an angle of 180° with a deviation of ±20°, preferably with a maximum deviation of ±8°, and particularly preferably with a maximum deviation of ±3°. In this case, through repeated deflection of the cooling air flow, it is advantageously possible to achieve an efficient separation of the heavy dust and/or dirt particles from the air. If in addition, at least one deflecting conduit section has a flow direction oriented opposite a gravitational force, it is possible to achieve a simply designed, in particular mass-dependent, separation of the heavy particles from the cooling air flow; this can be especially advantageous with stationary power tools in particular.

An advantageous collection of separated dirt particles can be achieved and in particular, a contamination of an interior of the power tool can be prevented if at least one of the deflecting conduit sections is provided with a chamber for the dirt particles to be deposited in. In this connection, a “chamber” should in particular be understood to mean an enclosed space with a housing; the housing, which in particular is embodied of a (sic.) that is separate from other components and/or elements of the power tool, preferably separates the enclosed space from other components and/or regions of the power tool.

In a particularly advantageous way, the deflecting unit has at least one supply conduit that is embodied in the form of an immersion tube. In this context, a supply conduit should in particular be understood to be a conduit that is provided for deliberately conveying the cooling air flow, which has been purified of dirt particles, in the direction toward the motor unit and/or electronics unit during operation of the power tool and additionally shields the purified cooling air flow from other components and/or regions of the power tool. In addition, an “immersion tube” should in particular be understood to mean a tube and/or conduit that extends at least partially into the deflecting unit, particularly into a separating chamber or deflecting region of the deflecting unit. This makes it possible to achieve a deliberate conveying away of a cooling air flow, which has been purified of dirt particles, and a particularly space-saving construction of the deflecting unit.

In addition, it is advantageously possible to increase a rotation of the cooling air flow, in particular around the immersion tube, thus improving an action of a centrifugal force for separating high-mass particles from low-mass particles in the cooling air flow if the deflecting conduit is situated at least partially around the immersion tube in one circumference direction.

According to another proposal, the ventilation unit has at least one intake conduit and at least one supply conduit and a flow direction of the cooling air flow in the intake conduit is oriented essentially opposite a flow direction of the cooling air flow of the supply conduit. This makes it possible to achieve a simply designed arrangement of the deflecting unit, thus advantageously keeping the power tool compact.

According to a proposed advantageous modification of the invention, at least one deflecting region of the deflecting unit has at least one outlet opening that is provided to permit the dirt particles to escape from the cooling air flow, thus making it possible to achieve an effective separation of the heavy dust and/or dirt particles from the air in the cooling air flow in the separating region or deflecting region. Preferably, in addition to the outlet opening, the deflecting unit can also have an additional main outlet opening that is provided to permit the purified cooling air flow to flow out.

According to another proposal, the outlet opening is situated in an outer wall of a bowed deflecting conduit section of the deflecting conduit, thus making it possible to achieve a simply designed separation of the heavy dust and/or dirt particles due to the centrifugal force acting on the dust and/or dirt particles.

If the ventilation unit has at least one outlet conduit that branches off from the deflecting conduit at the outlet opening, then it is advantageously possible to prevent an undesired contamination of an interior of the power tool. In this context, an “outlet conduit” should in particular be understood to be a conduit for conveying away in particular dust and/or dirt particles of the cooling air flow; the conduit preferably has a housing that is embodied separately from an inner wall of a machine housing and shields the dust and/or dirt particles from other components of the power tool, in particular a motor unit, etc. The outlet conduit can additionally feed into a collecting receptacle for dust and/or dirt and/or in a particularly advantageous way, feeds into the open air via an opening of the outlet conduit situated in the machine housing. In addition, the outlet conduit can contain a valve with an opening direction that permits a blowing-out of the heavy dust and/or dirt particles so that it is advantageously possible to prevent an undesired intake of an air flow through the outlet conduit.

The invention is also based on a filter device for a power tool equipped with at least one filter unit that has at least one filter element. According to this proposal, the filter unit has a dust removal device that is provided for removing dust from the filter element. In this context, a “filter element” should in particular be understood to be an element that is provided for separating dust particles and/or machining scrap in particular from a cooling air flow on the basis of the volume of the dust particles and/or machining scraps being larger than the volume of the air. Preferably, the filter unit in this case is situated in the vicinity of an intake opening of a ventilation unit. Through the embodiment according to the invention, it is advantageously possible to maintain a high cooling capacity of the filter device and in addition, to at least reduce and/or prevent a clogging of the filter pores of the filter element. This can also achieve a cost-reducing use with a low maintenance cost of the filter device in that it is possible to reduce a frequency with which the filter element must be replaced.

According to another proposal, the dust removal device has at least one dust removal element that rests against the filter element in at least one operating position, making it possible to achieve a particularly compact, simply designed arrangement of the dust removal device inside the filter device. In addition, the dust removal element can be coupled to a power switch element of the power tool so that the dust is removed from the filter element when the power tool is switched on and/or switched off and/or the dust removal element can be provided with a separate actuating element that is situated directly on the filter unit.

If the dust removal device has at least one spring element that is provided for producing a dust-removing motion of the dust removal element, the user can utilize it to produce a dust-removing motion in a simply designed way by simply moving the dust removal element in only one direction, e.g. pushing, pulling, etc., due to the fact that the spring force of the spring element is oriented in the opposite direction. The spring element can be embodied in the form of any spring element deemed suitable by the person of average skill in the art. In a particularly advantageous embodiment, however, the spring element is embodied in the form of a helical spring.

### DRAWINGS

Other advantages ensue from the following description of the drawings. The drawings show exemplary embodiments of the invention. The drawings, the description, and the claims contain numerous features in combination. The person of average skill in the art will also suitably consider the features individually and unite them in other meaningful combinations.

FIG. 1 is a sectional depiction of a power tool with a ventilation unit and a dirt separator unit,

FIG. 2 is a schematic, sectional depiction of a centrifugal force separator in the form of a spiral-shaped separator unit,

FIG. 3 is a schematic, sectional depiction of the power tool with an alternative embodiment of a centrifugal separator in the form of a U-shaped deflecting unit,

FIG. 4 is a detailed view of the U-shaped deflecting unit from FIG. 3,

FIG. 5 is a schematic, sectional partial depiction of an alternatively embodied deflecting unit,

FIG. 6 is a schematic, sectional depiction of the power tool with an alternative embodiment of a centrifugal separator in the form of a cyclone separator,

FIG. 7 is a schematic depiction of a dirt separator unit embodied in the form of a gravity separator,

FIG. 8 is a schematic depiction of a filter device for the power tool, equipped with a filter element and a dust removal element,

FIG. 9 is a schematic partial view of the filter device from FIG. 8 with a spring element in a first operating position, and

FIG. 10 is a schematic partial view of the filter device from FIG. 8 with the spring element in a second operating position.

### DESCRIPTION OF THE EXEMPLARY EMBODIMENTS

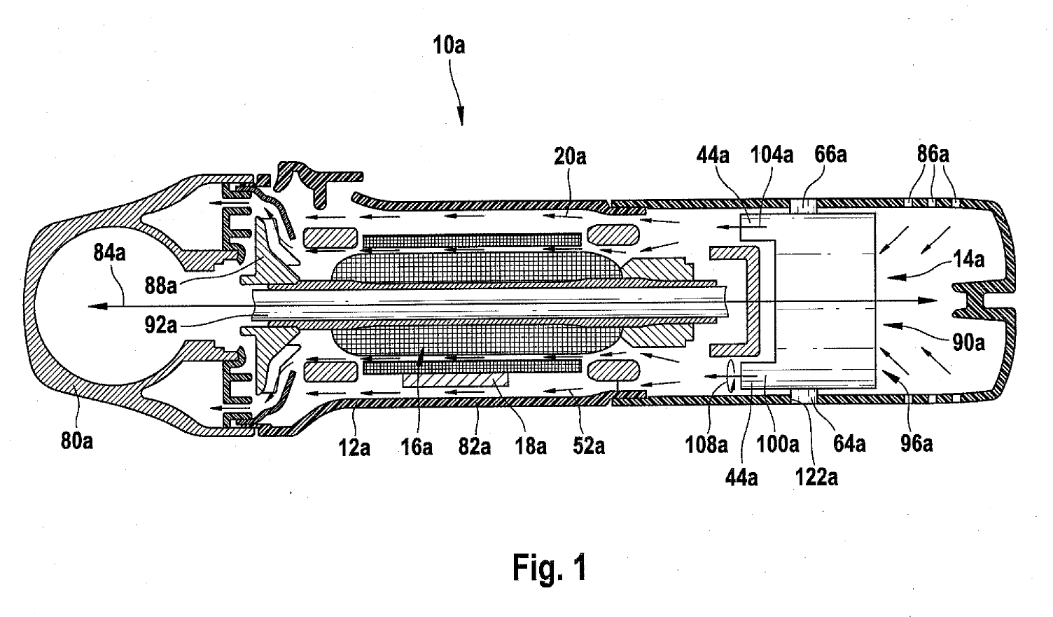

FIG. 1 is a schematic, sectional depiction of a power tool 10a embodied in the form of an angle grinder. The power tool 10a has a machine housing 12a that includes a transmission housing 80a and a motor housing 82a; the transmission housing 80a and motor housing 82a are situated one after the other along a main extension direction 84a of the power tool 10a. In addition, the power tool 10a has a motor unit 16a and an electronics unit 18a that are encompassed by the machine housing 12a or motor housing 82a. In order to cool the motor unit 16a and/or electronics unit 18a during operation of the power tool 10a, the power tool 10a is equipped with a ventilation unit 14a that is provided for drawing in a cooling air flow 20a. The ventilation unit 14a is situated in a region of the power tool 10a enclosed by the motor housing 82a. In addition, the power tool 10a or motor housing 82a has intake openings 86a—through which air is aspirated during operation of the ventilation unit 14a—and outlet openings, not shown in detail, through which the air is blown out after a cooling process.

The ventilation unit 14a has a fan impeller 88a and a dirt separator unit 90a. The fan impeller 88a is provided to produce a suction force during operation of the power tool 10a and sucks the cooling air flow 20a through the intake openings 86a. For this purpose, the fan impeller 88a is situated on a motor shaft 92a of the motor unit 16a and connected to it in rotating fashion. In a flow direction 52a of the cooling air flow 20a, the dirt separator unit 90a is situated before the motor unit 16a and electronics unit 18a, which are situated before the fan impeller 88a. The intake openings 86a are situated before the dirt separator unit 90a along the main extension direction 84a of the power tool 10a.

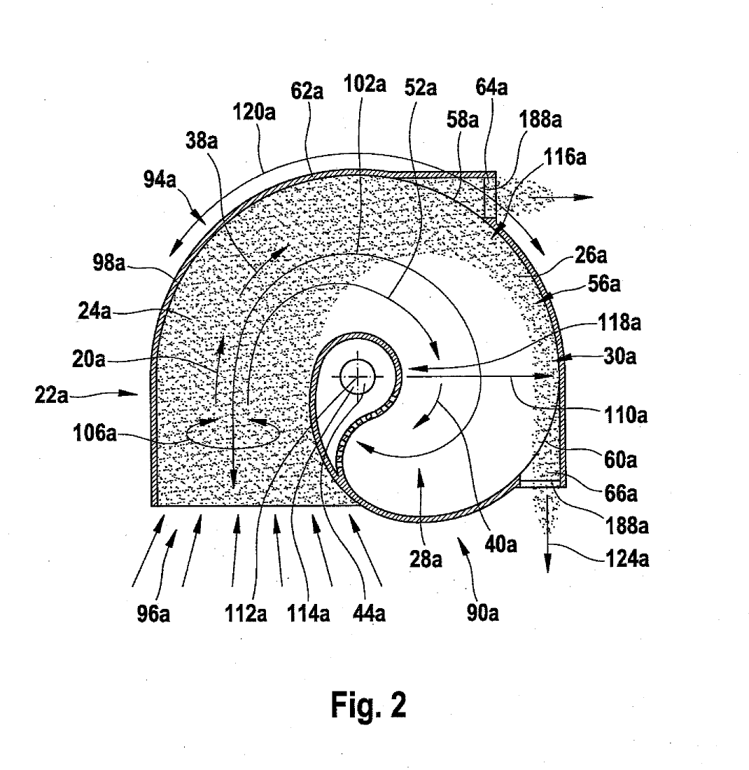

The dirt separator unit 90a is depicted in greater detail in FIG. 2 and is embodied in the form of a spiral centrifugal force separator 94a. The dirt separator unit 90a also has a deflecting unit 22a which is provided for deflecting the cooling air flow 20a, which results in a mass-dependent separation of heavy dust and/or dirt particles 26a from air 28a. The deflecting unit 22a has a deflecting conduit 24a, an intake region 96a, and a supply conduit 44a; the deflecting conduit 24a is situated between the intake region 96a and the supply conduit 44a along the flow direction 52a. The supply conduit 44a in this case is provided to deliberately convey purified air to the motor unit 16a and/or electronics unit 18a. The deflecting conduit 24a and the supply conduit 44a each have a conduit housing 98a, 100a, which extends along a longitudinal direction 102a, 104a in a circumference direction 106a, 108a around the deflecting conduit 24a and supply conduit 44a, thus advantageously preventing a diffuse escape of particles of the cooling air flow 20a from the deflecting conduit 24a and the supply conduit 44a.

The deflecting conduit 24a has a spiral-shaped deflecting conduit section 30a that feeds into the supply conduit 44a along the flow direction 52a. The spiral-shaped deflecting conduit section 30a is at least partially composed of an Archimedean spiral and has an essentially uniform cross-sectional area along the flow direction 52a. During operation of the ventilation unit 14a, the cooling air flow 20a is also moved inward in a radial direction 110a of the deflecting unit 22a from the outside, along the deflecting conduit 24a and feeds into the supply conduit 44a in the middle 112a via a main outlet opening 114a. At different positions along the longitudinal span 102a of the deflecting conduit 24a, the cooling air flow 20a has different respective movement directions 38a, 40a. By means of the spiral-shaped embodiment of the deflecting conduit section 30a, in the bowed or curved deflecting conduit 24a, the particles of the cooling air flow 20a are acted on by a centrifugal force oriented outward in the radial direction 110a of the deflecting unit 22a. This centrifugal force is dependent on a mass of the particles of the cooling air flow 20a so that the heavy dust and/or dirt particles 26a are deflected more powerfully outward in the radial direction 110a than the air 28a. The centrifugal force acting on the heavy dust and/or dirt particles 26a is also greater than a suction force produced in the deflecting conduit 24a by the fan impeller 88a so that the heavy dust and/or dirt particles 26a in the deflecting conduit 24a or more precisely, the spiral-shaped deflecting conduit section 30a, are deflected outward in the radial direction 110a and in an outer region 116a, move through the spiral-shaped deflecting conduit section 30a along the flow direction 52a. The air 28a of the cooling air flow 20a, however, is deflected more powerfully by the suction power of the impeller fan 88a during operation of the ventilation unit 14a than the heavy dust and/or dirt particles 26a and therefore travels through the deflecting conduit 24a or more precisely, the spiral-shaped deflecting conduit section 30a, in a region 118a situated toward the inside in the radial direction 110a so that due to the centrifugal force, a mass-dependent separation of particles and/or components of cooling air flow 20a occurs inside the spiral-shaped deflecting conduit section 30a.

The deflecting unit 22a also has two outlet openings 58a, 60a in a deflecting region 56a, or more precisely the spiral-shaped deflecting conduit section 30a, which are provided to permit the dust and/or dirt particles 26a. The two outlet openings 58a, 60a are situated in an outer wall 62a of the deflecting conduit 24a or spiral-shaped deflecting conduit section 30a in the radial direction 110a of the deflecting unit 22a. The outlet openings 58a, 60a are situated offset from one another by approximately 90° in a circumference direction 120a of the deflecting unit 22a. In addition, the ventilation unit 14a has two outlet conduits 64a, 66a that branch off from the deflecting conduit 24a at the outlet openings 58a, 60a. Along a flow direction into the outlet conduits 64a, 66a or along their longitudinal span, the outlet conduits 64a, 66a, also constitute a closed conduit that feeds out to the outside at the machine housing 12a of the power tool 10a via an opening 122a of the machine housing 12a. The two outlet conduits 64a, 66a each extend away from the deflecting conduit 24a in a tangential direction 124a of the deflecting conduit 24a, thus achieving an effective outflow by taking advantage of a mass inertia of the dust and/or dirt particles 26a during operation of the power tool 10a. During operation of the ventilation unit 14a, a partial air flow of the cooling air flow 20a with a high dust and/or dirt particle density flows through the respective outlet openings 58a, 60a and outlet conduits Ma, 66a while a partial flow of the cooling air flow 20a with a low dust and/or dirt particle density flows through the main outlet opening 114a. In addition, the outlet conduits 64a, 66a are each provided with a respective valve 188a having an opening direction that permits the dust and/or dirt particles 26a to be blown out thanks to a flow direction of the partial air flow containing the dust and/or dirt particles 26a and advantageously prevents an undesired intake of a cooling air flow 20a through the outlet conduits 64a, 66a.

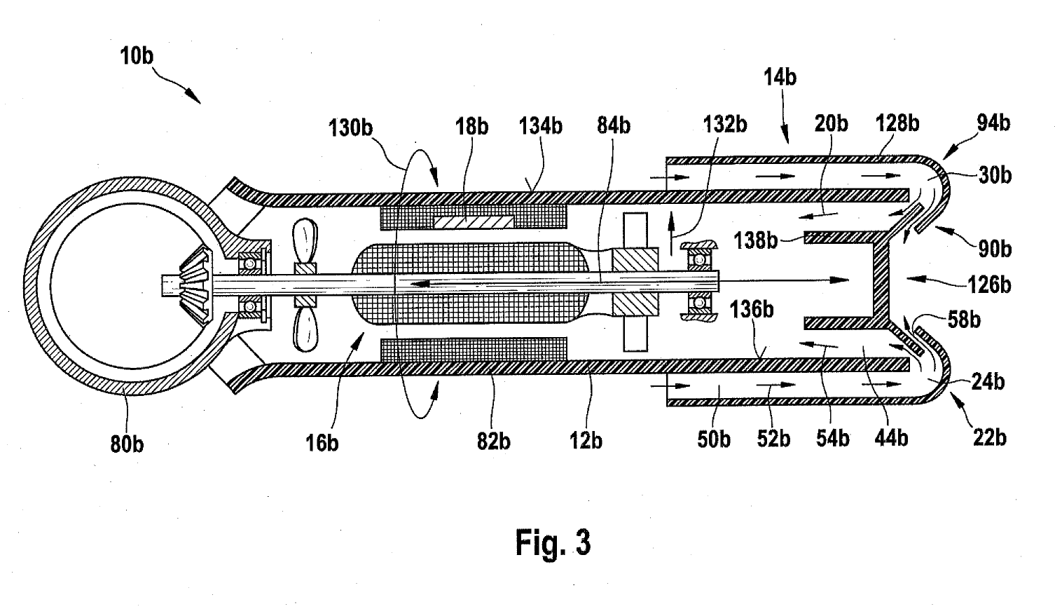

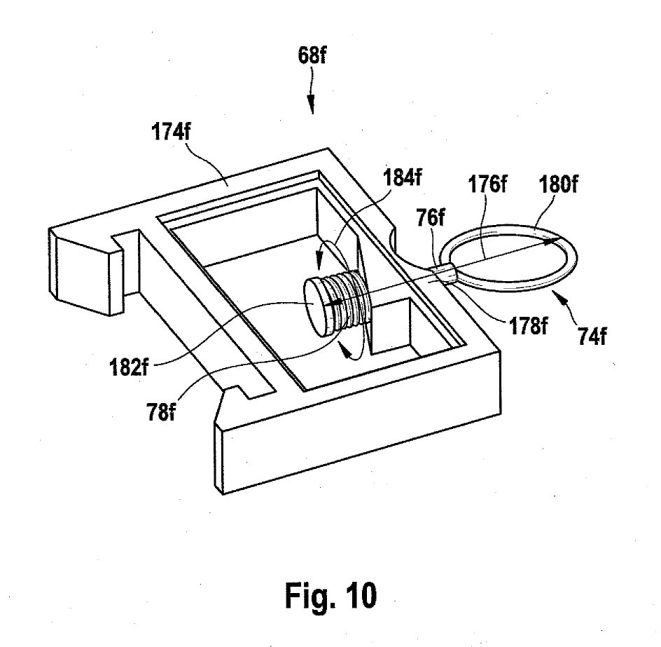

FIGS. 3 through 10 show alternative exemplary embodiments. Components, features, and functions that remain essentially the same have basically been provided with the same reference numerals. In order to differentiate among the exemplary embodiments, however, the letters a through f have been added to the reference numerals of the exemplary embodiments. The description below is limited essentially to the differences from the exemplary embodiment shown in FIGS. 1 and 2; descriptions of components, features, and functions that remain essentially the same can be found in the description of the exemplary embodiment shown in FIGS. 1 and 2.

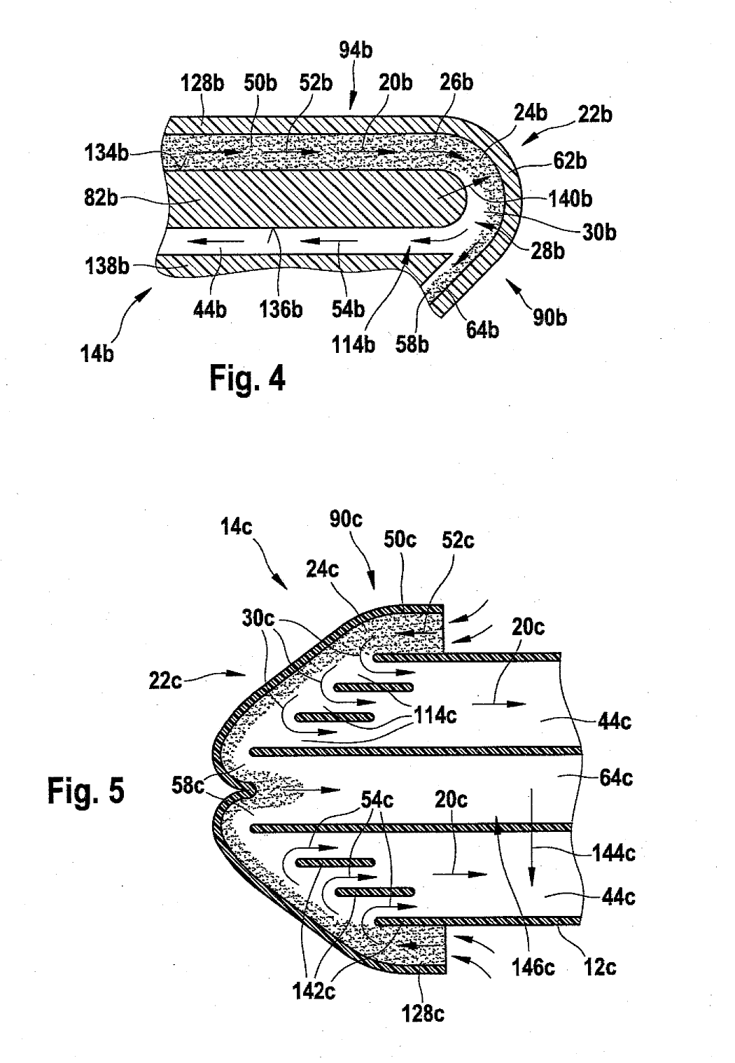

FIG. 3 shows a power tool 10b with a ventilation unit 14b that differs from the one shown in FIG. 2 and is provided for cooling a motor unit 16b and/or electronics unit 18b by drawing in a cooling air flow 20b. The ventilation unit 14b has a dirt separator unit 90b, which is embodied in the form of a U-shaped centrifugal force separator 94b and is equipped with a deflecting unit 22b (FIGS. 3 and 4). The deflecting unit 22b has an intake conduit 50b, a deflecting conduit 24b, and a supply conduit 44b; the deflecting conduit 24b is situated between the intake conduit 50b and the deflecting conduit 24b along a flow direction 52b, 54b. The flow direction 52b of the cooling air flow 20b in the intake conduit 50b here is oriented essentially opposite the flow direction 54b of the cooling air flow 20b in the supply conduit 44b. The deflecting unit 22b is situated in an end region 126b of a motor housing 82b oriented away from a transmission housing 80b along a main extension direction 84b of the power tool 10b. The deflecting conduit 24b has a bowed deflecting conduit section 30 that is embodied as U-shaped or ring segment-shaped and is situated in the end region 126b. The deflecting unit 22b has an additional housing casing 128b that is situated around the end region 126b of the motor housing 82b in a circumference direction 130b; the intake conduit 50b is situated between the additional housing casing 128b and a surface 134b of the motor housing 82b oriented outward in the radial direction 132b of the motor housing 82b. The intake conduit 50b here extends in the main extension direction 84b of the power tool 10b. The supply conduit 44b is situated between a surface 136b of the motor housing 82b oriented inward in the radial direction 132b and a guiding partition 138b of the dirt separator unit 90b and conveys a cooling air flow 20b that is purified of dust and/or dirt particles 26b along a main extension direction 84b of the power tool 10b from the end region 126b in the direction toward the motor unit 16b (FIGS. 3 and 4).

In addition, the deflecting unit 22b has an outlet opening 58b that is provided to permit an escape of a partial air flow of the cooling air flow 20b, which partial air flow has a high density of heavy dust and/or dirt particles 26b, during operation of the ventilation unit 14b. The outlet opening 58b is situated on an outer wall 62b in a radial direction 140b of the bowed deflecting conduit section 30b and an outlet conduit 64b of the ventilation unit 14b branches off at the outlet opening 58b. The outlet conduit 64b here is formed between the additional housing casing 128b and the motor housing 82b, which form an outlet conduit 64b oriented essentially inward in the radial direction 132b of the power tool 10b (FIGS. 3 and 4). In principle, a separation of heavy dust and/or dirt particles 26b from the air of the cooling air flow 20b occurs in a fashion analogous to the one in the exemplary embodiment shown in FIGS. 1 and 2. In another embodiment of the invention, it is also conceivable for the outlet conduit 64b to be provided with a valve that has an opening direction that permits the heavy dust and/or dirt particles 26b to be blown out along a flow direction of a partial air flow containing the dust and/or dirt particles and advantageously prevents an undesired intake of a cooling air flow 20b through the outlet conduit 64b. In order to increase a purifying action of the dirt separator unit 90b, it is also conceivable for the deflecting unit 22b to have a plurality of bowed or curved deflecting conduit sections 30b connected one after another.

FIG. 5 shows an alternative embodiment of a ventilation unit 14e for a power tool. The ventilation unit 14c has a dirt separator unit 90c with a deflecting unit 22c and an outlet conduit 64c. The deflecting unit 22c has a deflecting conduit 24c with a plurality of bowed deflecting conduit sections 30c. In addition, the deflecting unit 22c has an intake conduit 50c and a supply conduit 44c; a flow direction 52c of a cooling air flow 20c in the intake conduit 50c is oriented essentially opposite a flow direction 54c of the cooling air flow 20e in the supply conduit 44c. The deflecting conduit 24c has a plurality of main outlet openings 114c through which a virtually dirt-free partial air flow of the cooling air flow 20c can escape into the supply conduit 44c. The main outlet openings 114c are situated between partitions 142e of a machine housing 12c; the flow direction 52c of the cooling air flow 20c in the supply conduit 44c is oriented essentially parallel to a longitudinal span of the partitions 142c. In a direction 144c that extends transversely to the longitudinal span of the partitions 142c, the outlet conduit 64c is situated in a middle region 146c of the dirt separator unit 90c and is encompassed on both sides by the supply conduit 44c along this direction 144c. In addition, the supply conduit 44c is situated between the intake conduit 50c and the outlet conduit 64c along the direction 144c. A deflection of the cooling air flow 20c in the deflecting unit 22c occurs in a fashion analogous to the one in the exemplary embodiments shown in FIGS. 1 through 4.

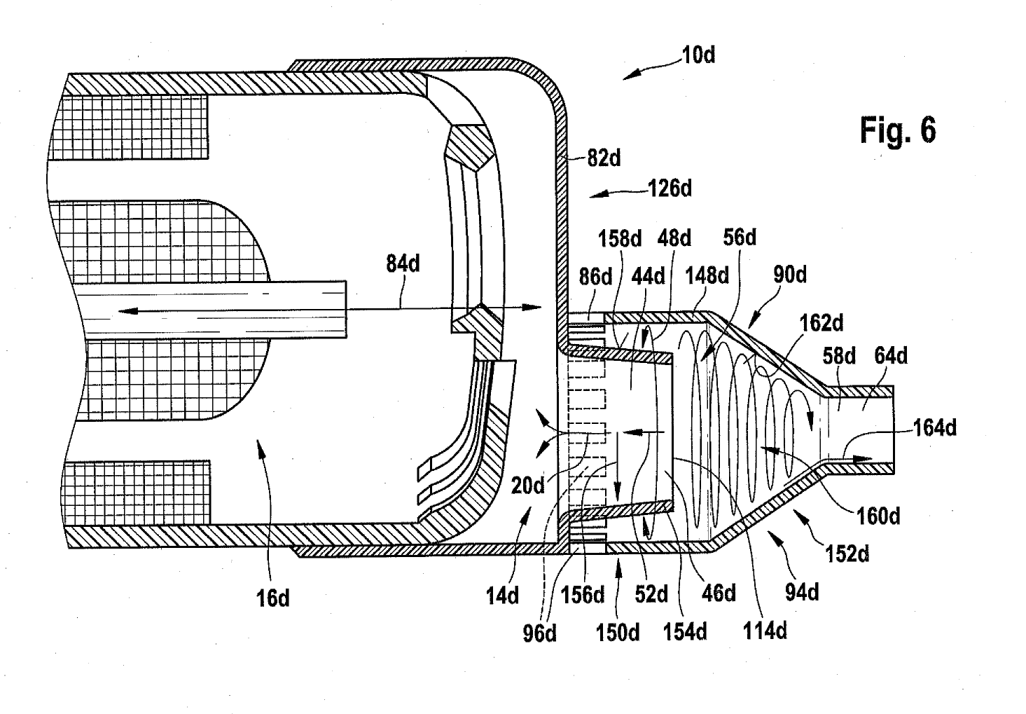

FIG. 6 shows an alternative embodiment of a power tool 10d with a ventilation unit 14d. The ventilation unit 14d has a dirt separator unit 90 constituted by a centrifugal force separator 94d embodied in the form of a cyclone separator. The dirt separator unit 90d is mounted on the power tool 10d in an end region 126d oriented toward the motor unit 16d along a main extension direction 84d of the power tool 10d. The dirt separator unit 90d has a separate housing 148d that extends away from a motor housing 82d of the power tool 10d along the main extension direction 84d of the power tool 10d. In a subregion 150d of the housing 148d oriented toward the motor housing 82d, the housing is embodied in the form of a cylinder extending along the main extension direction 84d; intake openings 86d are situated between the housing 148d and the motor housing 82d. A subregion 152d of the housing 148d oriented away from the motor housing 82d tapers conically along the main extension direction 84d from the motor unit 16d in the direction toward the dirt separator unit 90d and feeds into a cylindrical outlet conduit 64d along the main extension direction 84d. The motor housing 82d has a conically tapering extension 154d that extends into the subregion 150d of the housing 148d oriented toward the motor housing 82d; a cross-sectional area of the extension 154d is smaller than a cross-sectional area of the subregion 150d of the housing 148d. The extension 154d is embodied in the faint of a supply conduit 44d by means of which a partial air flow of the cooling air flow 20d that has been purified of dust and/or dirt particles is conveyed to the motor unit 16d and/or an electronics unit during operation. Basically, it is also conceivable for the dirt separator unit 90d to be situated inside the motor housing 82d, i.e. integrated into it.

During operation of the power tool 10d, the cooling air flow 20d is sucked in by means of an impeller fan, not shown in detail. In this case, air is sucked in through the intake openings 86d; a shape of the intake openings 86d is embodied so that the air is accelerated at least partially in a tangential direction or in a circumference direction 48d of the supply conduit 44d. The circumference direction 48d in this case extends around the supply conduit 44d perpendicular to the main extension direction 84d. In addition, the dirt separator unit 90d has a deflecting unit 22d with a deflecting conduit 24d that extends between the housing 148d and a surface 158d of the supply conduit 44d oriented outward in the radial direction 156d of the supply conduit 44d. The supply conduit 44d here is embodied in the form of an immersion tube 46d and extends into a deflecting region 56d of the deflecting unit 22d; the deflecting conduit 24d is situated around the immersion tube 46d in the radial direction 156d. The motor unit 16d also moves the aspirated air in the direction of the dirt separator unit 90 due to a suction force of the ventilation unit 14d so that the aspirated cooling air flow 20d rotates helically around the immersion to 46d in the circumference direction 48d. Because of the conically tapering subregion 152d of the housing 148d, the aspirated cooling air flow 20d rotates along helical orbits with a radius that decreases along the direction from the motor housing 82d toward the dirt separator unit 90d so that an increasing centrifugal force acts on the cooling air flow 20d in the direction toward the outside, resulting in a mass-dependent separation of the dust and/or dirt particles from the air of the cooling air flow 20d inside the deflecting unit 22d. In this case, the heavy dust and/or dirt particles are deflected outward in the radial direction 156d and deposited against a conically tapering housing wall 162d while the air, due to a suction force of the ventilation unit 14d, is deflected into an inner region 160d in the radial direction 156d. At an end of the conically tapered subregion 152d oriented away from the motor unit 16d, the air of the cooling air flow 20d, acted on by a suction force produced by the impeller fan, is deflected in the direction of the motor unit 16d along the flow direction 52d. The heavy dust and/or dirt particles are carried along together with a partial air flow 164d from the housing wall 162d in the direction of the outlet conduit 64d and conveyed away by it. A purifying action of the dirt separator unit 90d in this case can depend on a suction power of the ventilation unit and/or a geometry of the tapered. subregion 152d of the housing 148d and/or an orientation of the intake openings 86d and/or other components deemed suitable by the person of average skill in the art. In another embodiment of the invention, it is also conceivable for the outlet conduit 64a to be provided with a valve that has an opening direction that permits the dust and/or dirt particles to be blown out along a flow direction of the partial air flow containing the dust and/or dirt particles and advantageously prevents an undesired intake of a cooling air flow 20d through the outlet conduit 64a.

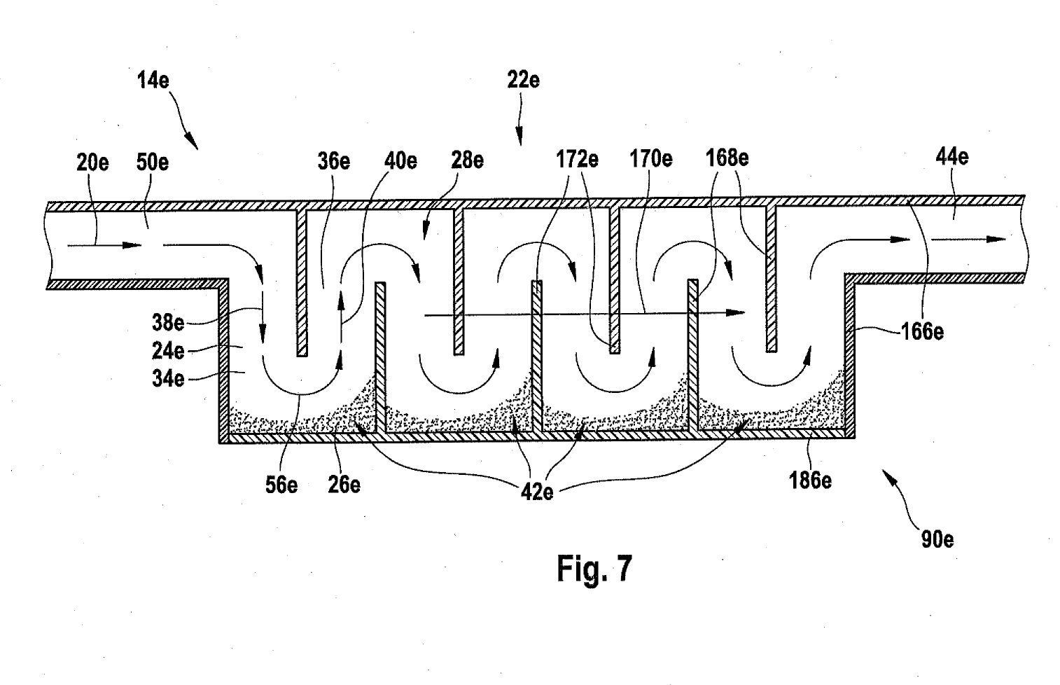

FIG. 7 shows an alternative dirt separator unit 90e of a power tool. The dirt separator unit 90e is constituted by a gravity separator unit and has a deflecting unit 22e with a deflecting conduit 24e that is provided for deflecting a cooling air flow 20e in order to separate dust and/or dirt particles 26e from the air 28e of the cooling air flow 20e. The deflecting conduit 24e has a plurality of deflecting conduit sections 34e, 36e; the deflecting conduit sections 34e, 36e are situated parallel to one another. In this case, a movement direction 38e of the cooling air flow 20e in the deflecting conduit section 34e is oriented opposite a movement direction 40e of the cooling air flow 20e in directly adjacent deflecting conduit sections 36e. For this purpose, the dirt separator unit 90e has two housing casings 166e, which are each embodied in comb-like fashion in the region of the deflecting unit 22e; comb tooth-like projections 168e protrude into the deflecting conduit 24e essentially perpendicular to the housing casings 166e. The comb tooth-like projections 168e of the two housing casings 166e here are situated offset from one another along the axial direction 170e of the deflecting conduit 24e so that a deflecting conduit section 34e, 36e is situated between each pair of comb tooth-like projections 168e. The cooling air flow 20e is deflected around the end 172e of each comb tooth-like projection 168e oriented away from the housing casing 166e on which the comb tooth-like projection 168e is situated. The deflecting unit 22e is integrated into the electrical appliance in such a way that with proper use of the electrical appliance, the movement direction 38e of the cooling air flow 20e in the deflecting conduit section 34e is essentially perpendicular to a gravitational force, which can be advantageous particularly in stationary electrical appliances. With heavy particles in the cooling air flow 20e, the force of gravity on the particles consequently acts in opposition to a suction force of the ventilation unit 14e so that these particles settle in the direction of the gravitational force. In addition, during the deflection, the heavy particles of the cooling air flow 20e are acted on by a powerful centrifugal force that deflects the particles outward so that they collide with the comb tooth-like projection 168e and are thus stopped. In order to gather or collect deposited dust and/or dirt particles 26e, the deflecting unit 22e has a plurality of chambers 42e that are situated in a deflecting region 56e in the deflecting conduit 24e. In addition, the chambers 42e are provided with a reclosable opening flap 186e, which permits a user of the electrical appliance to clean the chambers 42e. The opening flap 186e here can be opened and closed by means of a latch element, not shown in detail, on the opening flap 186e and is mounted onto the housing casing 166e in pivoting fashion. It is also conceivable, however, for the opening flap 186e to be activated and thus opened or closed by means of a power switch element of the power tool. In addition, the opening flap 186e can remain closed during operation of the ventilation unit due to a negative pressure in the deflecting conduit 24e and only transitions into an open state when operation ceases, driven by a spring force of a prestressed spring.

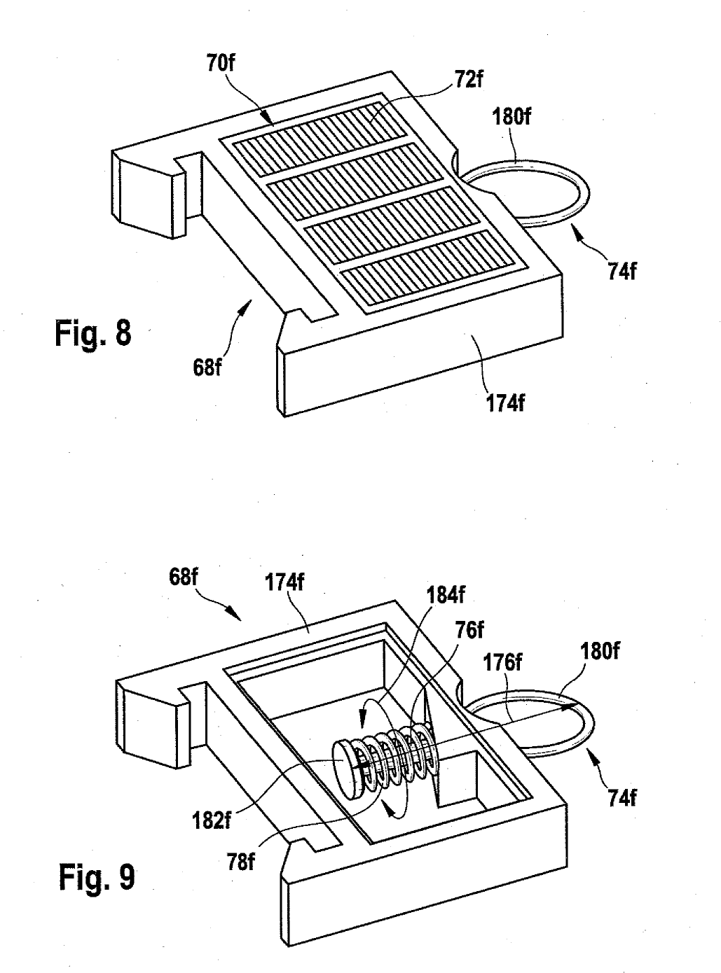

FIGS. 8 through 10 show a filter device 68f for a power tool. The filter device 68f has a filter unit 70f and a dust removal device 74f. The filter unit 70f includes a filter element 72f and a frame element 174f, which is provided for accommodating the filter element 72f and permits the filter element 72f to be fastened to the power tool. The dust removal device 74f is provided for removing dust from the filter element 72f and for this purpose, has a dust removal element 76f. The dust removal element 76f is supported on the frame element 174f so that it is able to move along a longitudinal direction 176f of the dust removal element 76f; the frame element 174f has a guide element 178f for this purpose. At an end oriented away from the filter element 72f along the longitudinal span 176f of the dust removal element 76f, the dust removal element has an actuating element 180f that permits a user to move the dust removal element 76f along its longitudinal span 176f. At an end oriented away from the actuating element 180f along the longitudinal span 176f of the dust removal element 76f, the dust removal element has a striking element 182f that strikes against the filter element 72f in order to remove dust from it. Along the longitudinal span 176f of the dust removal element 76f between the striking element 182f and the frame element 174f of the filter element 70f, a spring element 78f is provided, which is embodied in the form of a helical spring and is situated around the dust removal element 76f in a circumference direction 184f. In a relaxed operating position of the spring element 78f, the striking element 182f rests against the filter element 72f. In order to remove dust from the filter element 72f, the actuating element 180f together with the dust removal element 76f is moved in opposition to the spring force of the spring element 78f along the longitudinal span 176f in the direction from the striking element 182f toward the actuating element 180f. After the actuating element 180f is released, the spring force of the spring element 78f accelerates the dust removal element 76f along the longitudinal span 176f in the direction toward the filter element 72f so that it strikes against the filter element 72f in an end position. As a result, dust adhering to the filter element 72f is knocked loose and falls from the filter element 72f.

1-14. (canceled)

15. A power tool having:
a machine housing and a ventilation unit, which is provided for cooling a motor unit and/or electronics unit encompassed by the machine housing by drawing in a cooling air flow; and
a deflecting unit with at least one deflecting conduit provided for separating dirt particles from the air of the cooling air flow by means of a deflection of the cooling air flow.

16. The power tool according to claim 15, wherein the deflecting conduit has at least one bowed deflecting conduit section.

17. The power tool according to claim 15, wherein the deflecting conduit has at least one spiral-shaped deflecting conduit section.

18. The power tool according to claim 16, wherein the deflecting conduit has at least one spiral-shaped deflecting conduit section.

19. The power tool according to claim 15, wherein the deflecting conduit has a plurality of deflecting conduit sections and in at least one deflecting conduit section, the cooling air flow has a movement direction that is oriented essentially opposite a movement direction of adjacent deflecting conduit sections.

20. The power tool according to claim 16, wherein the deflecting conduit has a plurality of deflecting conduit sections and in at least one deflecting conduit section, the cooling air flow has a movement direction that is oriented essentially opposite a movement direction of adjacent deflecting conduit sections.

21. The power tool according to claim 17, wherein the deflecting conduit has a plurality of deflecting conduit sections and in at least one deflecting conduit section, the cooling air flow has a movement direction that is oriented essentially opposite a movement direction of adjacent deflecting conduit sections.

22. The power tool according to claim 18, wherein the deflecting conduit has a plurality of deflecting conduit sections and in at least one deflecting conduit section, the cooling air flow has a movement direction that is oriented essentially opposite a movement direction of adjacent deflecting conduit sections.

23. The power tool according to claim 15, wherein at least one of the deflecting conduit sections is provided with a chamber for dirt particles to be deposited in.

24. The power tool according to claim 22, wherein at least one of the deflecting conduit sections is provided with a chamber for dirt particles to be deposited in.

25. The power tool according to claim 15, wherein the deflecting unit has at least one supply conduit that is embodied in the form of an immersion tube.

26. The power tool according to claim 24, wherein the deflecting unit has at least one supply conduit that is embodied in the form of an immersion tube.

27. The power tool according to claim 25, wherein the deflecting conduit is situated at least partially around the immersion tube in one circumference direction of the immersion tube.

28. The power tool according to claim 15, wherein the deflecting unit has at least one intake conduit and at least one supply conduit and a flow direction of the cooling air flow in the intake conduit is oriented essentially opposite a flow direction of the cooling air flow of the supply conduit.

29. The power tool according to claim 15, wherein in at least one deflecting region, the deflecting unit has at least one outlet opening that is provided to permit the dirt particles to escape from the cooling air flow.

30. The power tool according to claim 29, wherein the outlet opening is situated in an outer wall of a bowed deflecting conduit section of the deflecting conduit.

31. The power tool according to claim 29, wherein the ventilation unit has at least one outlet conduit that branches off from the deflecting conduit at the outlet opening.

32. A filter device for a power tool having at least one filter unit that has at least one filter element, characterized in that the filter unit has a dust removal device that is provided for removing dust from the filter element.

33. The filter device according to claim 32, wherein the dust removal device has at least one dust removal element that rests against the filter element in at least one operating position.

34. The filter device according to claim 32, wherein the dust removal device has at least one spring element that is provided for producing a dust-removing motion of the dust removal element.
